(19) United States
(12) Patent Application Publication
(10) Pub. No.: US 2010/0140236 A1
(43) Pub. Date: Jun. 10, 2010

(54) LASER MACHINING SYSTEM AND METHOD

(75) Inventors: Guoshang Cai, Shanghai (CN); Kevin George Harding, Niskayuna, NY (US); Magdi Naim Azer, Niskayuna, NY (US); Yong Liu, Shanghai (CN); Sudhir Kumar Tewari, West Chester, OH (US); Robert William Tait, Niskayuna, NY (US); Xiaobin Chen, Shanghai (CN); Yanmin Li, Shanghai (CN); Huan Qi, Niskayuna, NY (US); David Henry Abbott, Mason, OH (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/328,349

(22) Filed: Dec. 4, 2008

(51) Int. Cl. B23K 26/00

(52) U.S. Cl. 219/121.72; 219/121.67

(57) ABSTRACT

A laser machining system comprises a laser configured to generate a laser output for forming a molten pool on a substrate, a nozzle configured to supply a growth material to the molten pool for depositing the material on the substrate, and an optical unit configured to capture a plurality of grayscale images comprising temperature data during the laser deposition process, wherein the grayscale images correspond to respective ones of a plurality of radiation beams with different desired wavelengths. Further, the laser machining system comprises an image-processing unit configured to process the grayscale images to retrieve the temperature data according to linear relationships between temperatures in the laser deposition process and the corresponding grayscales of the respective images. A laser machining method is also presented.

### BACKGROUND

This invention relates generally to laser machining systems and methods. More particularly, this invention relates to laser net-shape machining systems and methods.

Laser net-shape machining is an example of a laser-driven additive machining technique, wherein a high-energy density laser beam is used to drive localized deposition of material on a surface, and by repeating this process to build up a desired component. Such additive machining techniques stand in contrast to traditional machining techniques, in which material is removed from an original object until a desired part forms. The laser net-shape machining is a promising manufacturing technology, which can be widely applied in solid freeform fabrication, component recovery and regeneration, and surface modification.

In a laser net-shape laser deposition process, a laser beam is typically focused onto a locus on a toolpath of a growth surface to create thereabout a molten pool. The locus is then moved along the toolpath with a speed called the traverse velocity, pulling along with the molten pool, while a growth material (often a fusible powder, although feed wire has been used) is injected into the molten pool and becomes incorporated in the molten pool. Thus, the growth material is deposited onto the growth surface along the toolpath to create a material layer. The layers are then built upon one another until a desired component is fabricated.

In order to improve properties of the desired component, several efforts have been made to investigate the influence of process parameters on the properties of the desired component. Issues in the laser net-shape laser deposition process may comprise process repeatability, geometry accuracy and uniformity of microstructure properties.

The process parameters, such as laser power levels and powder flow rates, may affect temperature profiles in the molten pool and thermal behavior at each location of the desired component. Similarly, the temperature profile and the thermal behavior may determine the size of the molten pool and the micro-structural properties of the desired component. Accordingly, the thermal behavior is one important factor that influences the properties of the desired component. Thus, investigation of the thermal behavior in the laser net-shape laser deposition process could provide essential insight for the properties of the desired component.

Therefore, there is a need for a new and improved laser net-shape machining system and a method of use for investigation of temperature information in the laser deposition process.

### BRIEF DESCRIPTION

A laser machining system is provided in accordance with one embodiment of the invention. The laser machining system comprises a laser configured to generate a laser output for forming a molten pool on a substrate, a nozzle configured to supply a growth material to the molten pool for depositing the material on the substrate, and an optical unit configured to capture a plurality of grayscale images comprising temperature data during the laser deposition process, wherein the grayscale images correspond to respective ones of a plurality of radiation beams with different desired wavelengths. Further, the laser machining system comprises an image-processing unit configured to process the grayscale images to retrieve the temperature data according to linear relationships between temperatures in the laser deposition process and the corresponding grayscales of the respective images.

Another embodiment of the invention further provides a laser machining method. The laser machining method comprises generating a laser output for forming a molten pool on a substrate, supplying a material to the molten pool for depositing the material build-up on the substrate, and obtaining a plurality of grayscale images comprising temperature data during the laser deposition process, wherein the grayscale images correspond to respective ones of a plurality of radiation beams with different desired wavelengths. The laser machining method further comprises retrieving the temperature data from the grayscale images according to linear relationships between temperatures in the laser deposition process and the corresponding grayscales of the respective images.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a schematic diagram of a laser net-shape machining system in accordance with one embodiment of the invention;

FIGS. 2(a)-2(b) are schematic diagrams useful in explaining on-line thermal images captured by first and second optical units of the laser net-shape machining system shown in FIG. 1;

FIGS. 3(a)-3(b) are schematic diagrams of an example on-line grayscale image and an example thermal image captured by the first optical unit;

FIG. 4 is a schematic diagram of a temperature gradient vector of the example on-line thermal image shown in FIG. 3;

FIG. 5 is a schematic diagram of a temperature gradient intensity of the example on-line thermal image shown in FIG. 3 with cracks thereon;

FIG. 6 is an image of a deposition layer with the cracks shown in FIG. 5 thereon; and

FIGS. 7(a)-7(c) are schematic diagrams useful in explaining an example configuration of the first or second optical unit.

### DETAILED DESCRIPTION OF THE DISCLOSURE

Embodiments of the present disclosure will be described hereinbelow with reference to the accompanying drawings. In the subsequent description, well-known functions or constructions are not described in detail to avoid obscuring the disclosure in unnecessary detail.

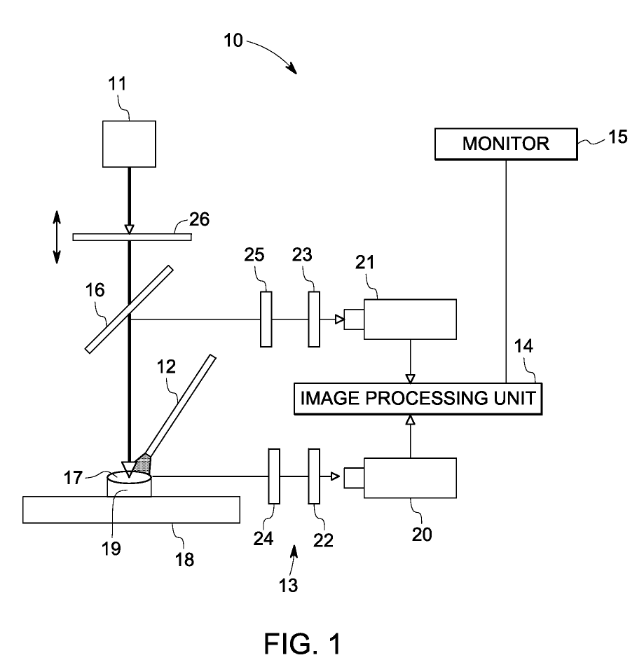

In embodiments of the invention, a laser net-shape machining system can be used to fabricate or repair components, non-limiting examples of which include, compressor blades, turbine blades, and compressor components. For the exemplary arrangement illustrated in FIG. 1, a laser net-shape machining system 10 comprises a laser 11, a nozzle 12, an optical unit 13, and an image-processing unit 14. The image-processing unit 14 may be separate or integrated into a computing device, such as a computer.

In the illustrated embodiment, the laser 11, such as a CO₂ laser is configured to generate a laser output to create a molten pool 17 on a substrate 18. The nozzle 12 delivers material (or “growth material”), such as metal powder material, into the molten pool 17 to deposit the material on the substrate 18. The deposited material (or “material build-up”) is indicated by reference number 19 in FIG. 1. Non-limiting examples of the growth material include titanium and titanium alloys, nickel and nickel alloys, cobalt and cobalt alloys, iron and iron alloys, superalloys including Ni-based, Co-based, or Fe based, ceramics, and plastics. In certain embodiments, more than one laser may be used to provide multiple laser outputs, so that the multiple laser outputs may be used to fabricate simultaneously or different laser outputs may be used to melt different growth materials. Additionally, more than one nozzle may be employed to feed the growth material to the molten pool 17 at multiple locations.

The optical unit 13 is configured to capture real-time grayscale images during the laser deposition (or “laser net-shape machining”) process. Then, the real-time grayscale images are sent to the image-processing unit 14, which may employ known image-processing algorithms, for processing to form thermal images and to retrieve the temperature data for the laser net-shape laser deposition process.

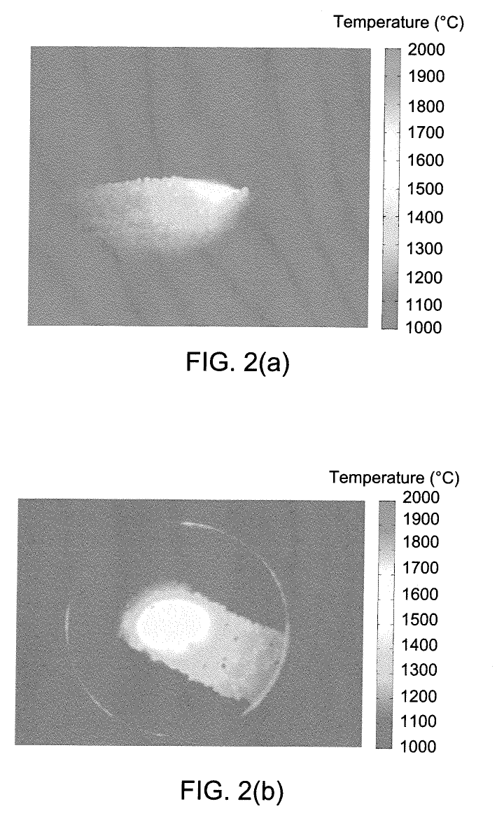

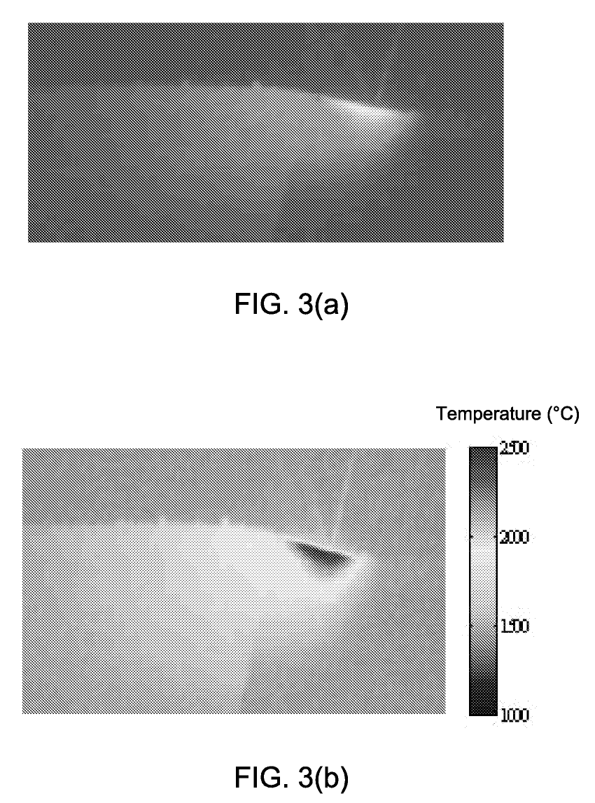

For the exemplary arrangement illustrated in FIG. 1, the optical unit 13 comprises a first optical unit 130 and a second optical unit 131. The first optical unit 130 comprises a first camera 20 for producing first on-line grayscale images, and the second optical unit 131 comprises a second camera 21 for producing second on-line grayscale images. In some embodiments, the second optical unit 131 may not be employed. In the illustrated arrangement, the first grayscale images are obtained from a side view of the laser deposition, which are related to the exemplary material build-up 19 and comprise temperature (thermal) data, such as temperature (thermal) gradients. In the illustrated arrangement, the second grayscale images are obtained from a top view of the laser deposition, which are related to the molten pool 17 and comprise temperature data, such as a cooling rate and a maximum temperature. For particular embodiments, the image-processing unit 14 is configured to analyze the first and second grayscale images to form first (side) thermal images related to the material build-up 19 and second (top) thermal images related to the molten pool 17, respectively. Referring to FIGS. 2(a)-2(b), an example side thermal image and an example top thermal image are illustrated. And referring to FIG. 3(a), an example side grayscale image is also illustrated. Additionally, the first and second cameras 20 and 21 may comprise, for example, complementary metal oxide semiconductor (CMOS) cameras or charge-coupled device (CCD) cameras.

In embodiments of the invention, radiation beams generated during the laser deposition process, designated here as first and second radiation beams (not labeled), are focused on the first and the second cameras to form the first and second grayscale images, respectively. In some examples, each of the first and second radiation beams may be composed of beams having different wavelengths. The image-processing unit 14 may retrieve the temperature data related to the material build-up 19 and the molten pool 17 based on Plank's law by analyzing the respective first and second grayscale images formed by the first and second radiation beams.

As known to one skilled in the art, according to Planck's law, to a selected radiation wavelength λ, a sensor response N(T) of one point on a camera may be expressed as:

$$N ( T ) = kt Δλη ( λ ) \frac{ɛ ( λ , T )}{{λ}^{5} ( {e}^{{C}_{2} / λ T} - 1 )} \qquad ( 1 )$$

Wherein k denotes a heat-electricity transfer coefficient, t denotes a camera exposure time, Δλ denotes a radiation-interval width, η(λ) denotes a relative spectral sensitivity of the camera, T denotes a temperature of one point on a component being detected, ε(λ,T) denotes a material emissivity of the component being detected, and C₂ is a constant. The sensor responses N(T) of points on a camera may be grayscales of the points on the camera. To a grayscale image captured by the camera, the sensor responses N(T) of the points on the camera may also be grayscales of corresponding points on the captured grayscale image. In some examples, t may be less than or about 10 ms, and λ may be in a range of 0.6-1.0 um. In other examples, λ may be higher than 1.0 um.

In certain embodiments, one can take the first camera 20 capturing the side grayscale images as an example. For two radiation beams having different wavelengths λ₁ and λ₂ radiated from the same point on the material build-up 19, the first camera 20 captures the two radiation beams to form two different grayscale images. In non-limiting examples, two radiation beams may be radiated at the same temperature, and detected by the first camera 20 simultaneously. Then, the two different grayscale images are sent to the image-processing unit 14 for processing. According to the equation (1), a ratio R of the N(λ₁, T) and N(λ₂, T) can be expressed as:

$$R = \frac{N ( {λ}_{1} , T )}{N ( {λ}_{2} , T )} = \frac{kt {Δλ}_{1} η ( {λ}_{1} ) ɛ ( {λ}_{1} , T ) / {λ}_{1}^{5} ( {e}^{{C}_{2} / {λ}_{1} T} - 1 )}{kt {Δλ}_{2} η ( {λ}_{2} ) ɛ ( {λ}_{2} , T ) / {λ}_{2}^{5} ( {e}^{{C}_{2} / {λ}_{2} T} - 1 )} \qquad ( 2 )$$

According to Planck's law, the material build-up 19 may be a greybody. Therefore, ε(λ₁,T) is equal to ε(λ₂,T). Additionally, the wavelength λ₁ may be approximate to the wavelength λ₂, Δλ₁ may be selected to be equal to Δλ₂. Accordingly, the above equation (2) can be simplified as:

$$R = \frac{η ( {λ}_{1} ) / {λ}_{1}^{5} ( {e}^{{C}_{2} / {λ}_{1} T} - 1 )}{η ( {λ}_{2} ) / {λ}_{2}^{5} ( {e}^{{C}_{2} / {λ}_{2} T} - 1 )}$$

For a given camera such as the first camera 20, the ratio R, and the spectral sensitivity η(λ₁) and η(λ₂) can be determined. Thus, referring to FIG. 1, the temperature T of the one point on the material build-up 19 can be determined by retrieving the temperature data in the two different grayscale images. Similarly, the temperature data of other points on the material build-up 19, which are captured by the first camera 20, may also be determined so that a side thermal image related to the material build-up 19 may be formed. Referring to FIG. 3(b), an example side thermal image is illustrated. As illustrated in FIG. 1, the laser net-shape machining system further comprises a monitor 15 such as a liquid crystal display (LCD), connected to the image-processing unit 14 for observing the thermal images in the laser deposition process.

In certain embodiments, equation (1) may be logarithmically transformed as follows:

ln N(T)=ln [ktΔλη(λ)ε(λ,T)]−5 ln λ−ln(e^{C}^{₂}^{/λT}−1) (3)

In some embodiments of the invention, the temperature during the laser deposition process may be high, such as about or more than 1000° C. Thus, e^{C2/λT}>>1. Accordingly, the equation (3) can be simplified as:

$$ln N ( T ) \approx ln [ kt Δλη ( λ ) ɛ ( λ , T ) ] - 5 ln λ - \frac{{C}_{2}}{λ T} \qquad ( 4 )$$

Then, equation (4) may be transformed as:

$$ln N ( T ) - ln [ η ( λ ) ] + 5 ln λ \approx - \frac{{C}_{2}}{λ} \frac{1}{T} + ln [ kt Δλɛ ( λ , T ) ] \qquad ( 5 )$$

For the radiation beams with different wavelengths, the expressions “lnN(T)−ln [η(λ)]+5 ln λ” and “—C₂/λ” can be determined, and in non-limiting examples, may be defined as Y and X, respectively. The expression “ln [ktΔλε(λ₁,T)]” may be defined as b. Accordingly, equation (5) may be transformed as:

$$Y = \frac{1}{T} X + b \qquad ( 6 )$$

As can be seen, for one selected radiation wavelength λ, the temperature T of the detected component may be linearly related to the grayscale N(T) of the grayscale image, and may be a slope of a line deduced from the linear equation (6). Thus, for two radiation beams with the different wavelengths λ₁ and λ₂, it is easier to calculate the temperature T of one point on the material build-up 19 by analyzing the two different grayscale images according to equation (6). Thus, the temperature of other points on the material build-up 19 may also be determined.

In other embodiments, the first camera 20 may capture more than two grayscale images, such as three simultaneously, formed by three radiation beams with different wavelengths λ₁, λ₂ and λ₃. Thus, according to the linear equation (6), three different linear relationships may be formed. Then, a least square method, which is known to one skilled in the art, may be used to perform curve fitting to the different linear relationships to determine the temperature of points on the material build-up 19 in the image-processing unit 14. Therefore, the temperature data, such as temperature (thermal) gradient may also be determined in the image-processing unit 14. Additionally, similar to the processing of the side grayscale images, the temperature (thermal) data in the top grayscale images may also be retrieved from the second grayscale images.

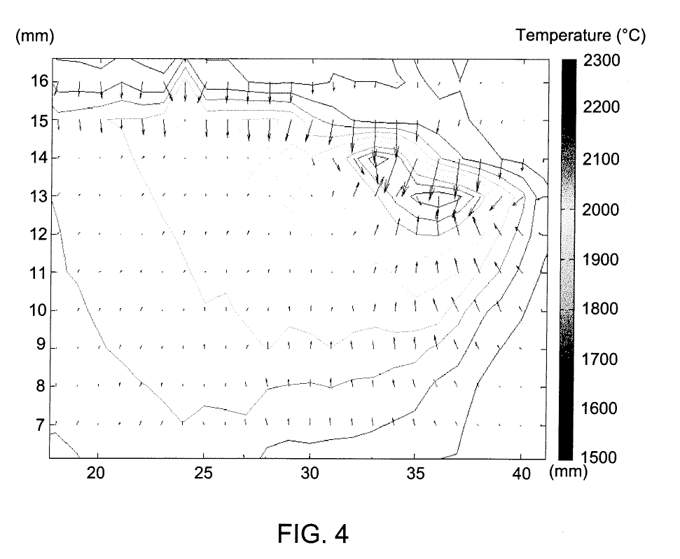

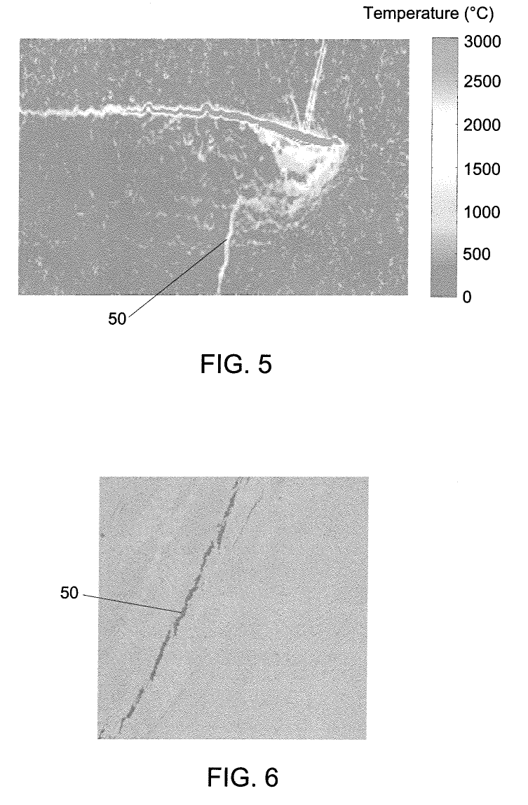

In certain embodiments, the temperature gradient may be expressed in terms of gradient vectors and gradient intensity. FIG. 4 illustrates a schematic diagram of a temperature gradient vector of the example on-line thermal image shown in FIG. 3(b). FIG. 5 illustrates a schematic diagram of a temperature gradient intensity of the example on-line thermal image shown in FIG. 3(b). As illustrated in FIGS. 4-5, from the gradient vector and/or the gradient intensity, the spatial and temporal distribution and variation of the temperature during the laser deposition of the material build-up 19 may be determined, which may provide information for investigating the laser deposition (machining) process. In some examples, as illustrated in FIG. 5, the gradient intensity may also be used to detect defects, such as crack 50 in the material build-up 19 when the crack 50 occur, to provide insight for avoiding the crack 50 and improving the properties of the material build-up 19. As illustrated in FIG. 6, after one deposition layer of the material build-up 19 is completed, an image of the deposition layer captured off-line to verify the occurrence of the crack 50. Thus, the cracks may be detected in real time by analyzing the temperature data of the side thermal images in the laser deposition process. Additionally, the temperature data of the molten pool 17, such as a cooling rate and a maximum temperature may also be determined by analyzing the top thermal images.

The exemplary arrangement in FIG. 1, is configured such that the first or second cameras 20 or 21 can capture two or more grayscale images formed by the respective radiation beams with different wavelengths simultaneously. More particularly, for the illustrated configuration, the first optical unit 130 further comprises a first lens 22 and a first band pass filter 24. The second optical unit 131 further comprises a second lens 23, a second band pass filter 25, and a beam splitter 16. The splitter 16 is disposed to split and direct the radiation beams from the molten pool 17 to pass through the second band pass filter 25 and the second lens 23 into the second camera 21. In one embodiment, the radiation beams from the molten pool 17 may be coaxial with an axis of the laser so that the thermal images of the molten pool 17 may be kept stably along a toolpath. As used herein, a path that the laser takes along the substrate is referred to as a toolpath.

In the illustrated embodiment, the first and second lens 22 and 23 are disposed in front of and focus the first and second radiation beams on the first and second cameras 20 and 21, respectively. The first and second band pass filters 24 and 25 are disposed in front of the first and second lens 22 and 23 for the radiation beams with desired wavelengths passing through, respectively. Alternatively, the first and second band pass filter 24 and 25 may be disposed between the first lens 22 and the first camera 20, and between the second lens 23 and the second camera 21, respectively.

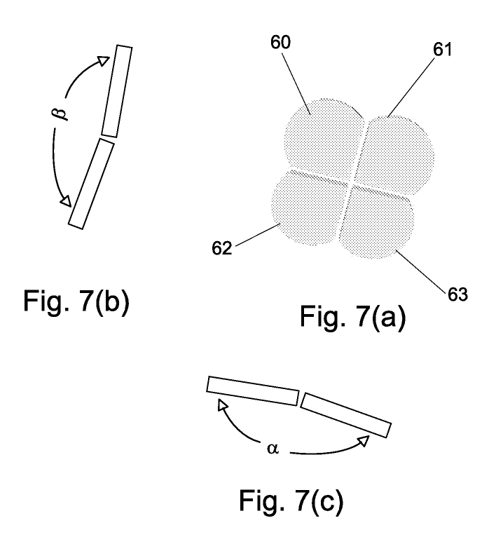

In one non-limiting example, FIG. 7(a) illustrates a schematic diagram useful in explaining an example configuration of the first and/or second lens. Taking one of the first and second lens as an example, as illustrated in FIG. 7(a), the lens may comprise four-segmented lenses 60, 61, 62 and 63. FIGS. 7(b)-7(c) illustrate a side view and a top view of the configuration of the four-segmented lenses 60, 61, 62 and 63, respectively. As illustrated in FIG. 7(b), angles β between the lens 60 and the lens 62, and between the lens 61 and the lens 63 may be less than 180 degrees, such as 179.2 degrees. As illustrated in FIG. 7(c), angles α between the lens 60 and the lens 61, and between the lens 62 and the lens 63 may also be less than 180 degrees respectively, such as 179.2 degrees. Thus, four radiation beams may be focused on different locations of the respective camera 20 or 21 simultaneously after passing through the first lens 22 or the second lens 23.

Corresponding to the configuration of the first and second lens 22 and 23, each of the first and second band pass filters 24 and 25 may comprise four different filters each for a radiation beam with a desired wavelength passing through. Accordingly, cooperation of the filters and the respective lens focus the first and second radiation beams having different wavelengths on the respective cameras. Alternatively, two or three radiation beams may also be accommodated by using two or three of the four-segmented lens. It should be noted that the segmented lenses are illustrative and may have other shapes.

In certain embodiments, the laser net-shape machining system 10 may employ four-segmented reflected mirrors in place of the four-segmented lenses. Alternatively, the laser net-shape machining system 10 may employ other suitable devices such that one camera can capture different grayscale images formed by radiation beams with different wavelengths. For example, a filter wheel (not shown) having different filters may be employed, which is known to one skilled in the art, and in this situation, the lenses 22 and 23 may not be employed.

Further, the system 10 may comprise a lens 26, which is disposed on the transmission path of the laser so that the size of the laser spot on the surface of the substrate 18 may be adjusted by moving the lens 26 up and down. In particular, the lens 26 is in a position where the surface of the substrate 18 is away from an adjacent focal plane of the lens 26. In one embodiment, the laser light spot size may be about 1 mm.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A laser machining system, comprising:
a laser configured to generate a laser output for forming a molten pool on a substrate;
a nozzle configured to supply a growth material to the molten pool for depositing the material on the substrate;
an optical unit configured to capture a plurality of grayscale images comprising temperature data during the laser deposition process, wherein the grayscale images correspond to respective ones of a plurality of radiation beams with different desired wavelengths; and
an image-processing unit configured to process the grayscale images to retrieve the temperature data according to linear relationships between temperatures in the laser deposition process and the corresponding grayscales of the respective images.

2. The laser machining system of claim 1, wherein the optical unit captures the grayscale images simultaneously.

3. The laser machining system of claim 1, wherein the grayscale images comprise a set of first grayscale images related to the laser deposition of the material on the substrate, and wherein the radiation beams comprise first radiation beams with different desired wavelengths for forming the first grayscale images in the optical unit.

4. The laser machining system of claim 3, wherein the optical unit comprises a first optical unit comprising a first camera configured to capture the first grayscale images and a first filter configured to form the first radiation beams.

5. The laser machining system of claim 4, wherein the first optical unit further comprises a first lens configured to cooperate with the first filter to focus the first radiation beams with different desired wavelengths on different locations of the first camera.

6. The laser machining system of claim 5, wherein the first lens comprises two or more segmented lenses, each of the segmented lenses being configured for directing one of the first radiation beams to the respective location within the first camera.

7. The laser machining system of claim 3, wherein the image-processing unit processes the set of first different grayscale images to retrieve the temperature data for detecting a crack within the laser deposited material, if the crack occurs.

8. The laser machining system of claim 7, wherein the temperature data comprises thermal gradient intensity.

9. The laser machining system of claim 4, wherein the grayscale images further comprise a set of second grayscale images related to the molten pool, and wherein the corresponding radiation beams comprise a plurality of second radiation beams with different desired wavelengths for forming the second grayscale images within the optical unit.

10. The laser machining system of claim 9, wherein the optical unit further comprises a second optical unit comprising a second camera configured to capture the second grayscale images and a second filter configured to form the second radiation beams.

11. The laser machining system of claim 10, wherein the second optical unit further comprises a second lens configured to cooperate with the second filter to focus the second radiation beams in the second camera.

12. The laser machining system of claim 9, wherein the temperature data comprises at least one of a cooling rate or a maximum temperature.

13. A laser machining method, comprising:
generating a laser output for forming a molten pool on a substrate;
supplying a material to the molten pool for depositing the material build-up on the substrate;
obtaining a plurality of grayscale images comprising temperature data during the laser deposition process, wherein the grayscale images correspond to respective ones of a plurality of radiation beams with different desired wavelengths; and
retrieving the temperature data from the grayscale images according to linear relationships between temperatures in the laser deposition process and the corresponding grayscales of the respective images.

14. The laser machining method of claim 13, wherein the grayscale images comprise a set of first grayscale images related to the laser deposition of the material on the substrate, and wherein the radiation beams comprise first radiation beams with different desired wavelengths for forming the first grayscale images.

15. The laser machining method of claim 14, wherein the temperature data in the set of the first grayscale images comprise thermal gradient intensity data.

16. The laser machining method of claim 14, wherein the temperature data in the first grayscale images are retrieved for detecting a crack on the component within the laser deposited material, if the crack occurs.

17. The laser machining method of claim 14, wherein the first grayscale images are obtained using a first optical unit comprising a first camera configured to capture the first grayscale images and a first filter configured to form the first radiation beams with different desired wavelengths.

18. The laser machining method of claim 17, wherein the grayscale images further comprise a set of second grayscale images related to the molten pool, and wherein the respective ones of the radiation beams comprise second radiation beams with different desired wavelengths for forming the second grayscale images.

19. The laser machining method of claim 18, wherein the second grayscale images are obtained using a second optical unit comprising a second camera configured to capture the second grayscale images and a second filter configured to form the second radiation beams with different desired wavelengths.
